(19) United States
(12) Patent Application Publication
(10) Pub. No.: US 2011/0287249 A1
(43) Pub. Date: Nov. 24, 2011

(54) ANTI-EROSION LAYER FOR AERODYNAMIC COMPONENTS AND STRUCTURES AND METHOD FOR THE PRODUCTION THEREOF

(75) Inventors: Erwin Bayer, Dachau (DE); Juergen Steinwandel, Uhldingen-Muehlhofen (DE)

(73) Assignee: AIRBUS OPERATIONS GMBH, Hamburg (DE)

(21) Appl. No.: 13/102,455

(22) Filed: May 6, 2011

Related U.S. Application Data
(63) Continuation of application No. PCT/DE2009/001560, filed on Nov. 9, 2009.

(30) Foreign Application Priority Data
Nov. 10, 2008 (DE) 102008056578.4

(51) Int. Cl. B32B 5/16; C09D 1/00; B05D 1/36

(52) U.S. Cl. 428/323; 427/203; 106/286.5; 106/286.1; 106/287.17; 106/287.3; 106/287.1

(57) ABSTRACT

An anti-erosion layer is provided for aerodynamic components or structures and to a method for producing such a layer. Microscale or nanoscale hard material particles are embedded in a binding layer that includes a material that adheres to the aerodynamic component or structure. The anti-erosion layer can be applied by spraying or by evaporation coating.

### CROSS-REFERENCE TO RELATED APPLICATIONS

This application is a continuation of International Application No. PCT/DE2009/001560, filed Nov. 9, 2009, which was published under PCT Article 21(2) and which claims priority to German Patent Application No. 102008056578.4 filed Nov. 10, 2008, which are hereby incorporated herein by reference.

### TECHNICAL FIELD

The invention relates to an anti-erosion layer for aerodynamic components and structures, and to a method for producing such a layer.

### BACKGROUND

Aerodynamic components and structures, for example compressor blades of engines, fan blades or propeller blades, helicopter rotors, wing leading edges etc., in particular in the case of fibre composite materials, depending on their operational profile, the aerodynamic loads encountered by them, and the specific materials used, are subject to wear by flow-borne particles such as water, dust, coarser particles etc. Such erosion of flow profiles results in deviations from, and destruction of, profile trueness, which is associated with increased flow resistance and deteriorated aerodynamic efficiency. Furthermore, the material of the aerodynamic components or structures can be degraded as a result of crack formation. Anti-erosion layers on such components can considerably delay such form of ageing. Until now, coating systems comprising alternating sequences of hard and soft layers have been used to provide protection against erosion on aerodynamic components and structures.

It may be at least one object of the invention to create an anti-erosion layer for aerodynamic components and structures, which layer features good effectiveness and durability and can be produced with little expenditure. Furthermore, a method for producing such an anti-erosion layer may be provided.

### SUMMARY

The at least one object of the invention is met by an anti-erosion layer for aerodynamic components and structures and a method for producing an anti-erosion layer. The invention results in an anti-erosion layer for aerodynamic components and structures in which a plurality of hard material particles are embedded in a binding layer comprising a material that adheres well to the aerodynamic components or structures.

The hard material particles can predominantly have a diameter in the micrometre range. The hard material particles can predominantly have a diameter in the nanometre range. The hard material particles can predominantly have a diameter of less than approximately 200 μm. The hard material particles can predominantly have a diameter of between approximately 8 μm and approximately 80 μm. The hard material particles can predominantly have a diameter of between approximately 0.8 μm and approximately 8 μm. The hard material particles can predominantly have a diameter of between approximately 80 nm and approximately 800 nm. The hard material particles can predominantly have a diameter of between approximately 8 nm and approximately 80 nm. The hard material particles can predominantly have a diameter of less than approximately 8 nm.

According to an embodiment of the invention, the hard material particles predominantly have the same or substantially the same diameter. According to another embodiment of the invention, the hard material particles have different diameters. The hard material particles can have different diameters from one or from several of the above-mentioned ranges, or they can have diameters outside these ranges.

The hard material particles can be made from one or several of the materials comprising ceramics, cubic boron nitride (CBM), silicates, carbides or (other) nitrides or diamond-like carbon particles.

The binding layer can be metallic, organic or inorganic. According to an embodiment of the invention, the binding layer accounts for less than approximately 60% by volume, preferably less than approximately 40% by volume, of the anti-erosion layer.

Furthermore, the invention provides a method for producing an anti-erosion layer for aerodynamic components and structures of the type mentioned, in which method the anti-erosion layer is applied to the aerodynamic component or structure by spraying a mixture comprising a material, which forms the binding layer, and the hard material particles.

Furthermore, the invention provides a method for producing an anti-erosion layer for aerodynamic components and structures of the type mentioned above, in which method the anti-erosion layer is produced by evaporation coating a material that forms the binding layer onto the aerodynamic component or structure, wherein the hard material particles are introduced into a cloud of vapour of the material forming the binding layer, and together with this material are applied to, or precipitated on, the aerodynamic component or structure.

According to an advantageous embodiment of the method according to the invention, the anti-erosion layer is applied to the aerodynamic component or structure at a desired layer thickness in a single operation.

### BRIEF DESCRIPTION OF THE DRAWINGS

The present invention will hereinafter be described in conjunction with the following drawing figures, wherein like numerals denote like elements, and:

FIG. 1 a diagrammatic enlarged view of part of an aerodynamic component or structure to which an anti-erosion layer according to an exemplary embodiment of the invention has been applied;

FIG. 2 a diagrammatic view of a method for producing an anti-erosion layer on an aerodynamic component or structure according to an exemplary embodiment of the invention; and

FIG. 3 a diagrammatic view of a method for producing an anti-erosion layer on an aerodynamic component or structure according to a further exemplary embodiment of the invention.

### DETAILED DESCRIPTION

The following detailed description is merely exemplary in nature and is not intended to limit application and uses. Furthermore, there is no intention to be bound by any theory presented in the preceding background or summary or the following detailed description.

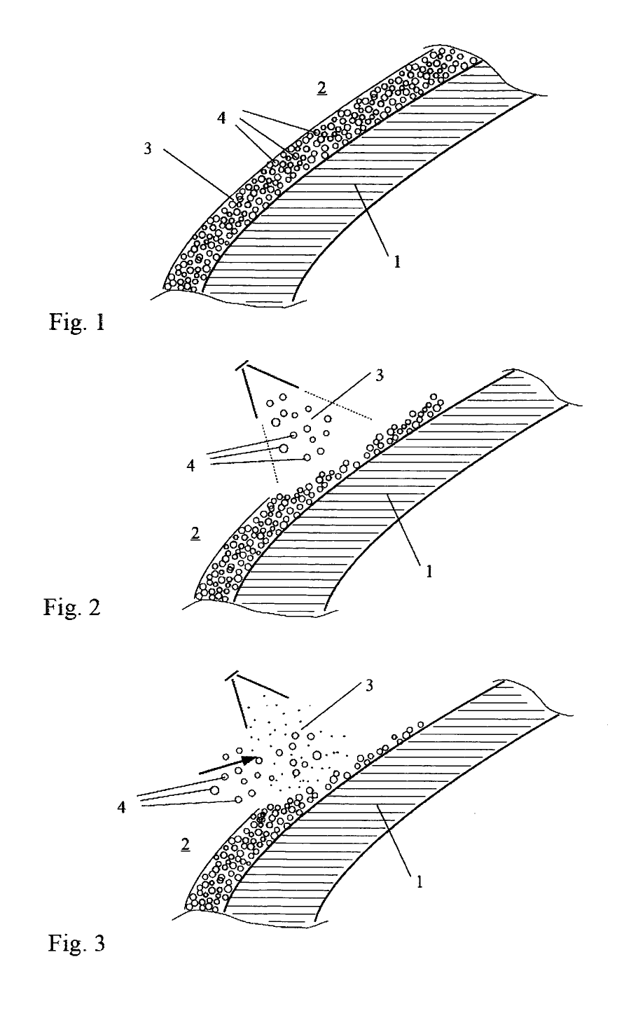

FIG. 1 diagrammatically and in cross-sectional view shows part of an aerodynamic component or structure 1, for example a compressor blade of an engine, a fan blade or propeller blade, a helicopter rotor, a wing leading edge or some other aerodynamically effective component. An anti-erosion layer 2 has been applied to the aerodynamic component 1, which anti-erosion layer 2 is designed to provide protection against wear resulting from flow-borne particles such as water, dust, larger particles etc. This anti-erosion layer 2 comprises a binding layer 3 of a material that adheres well to the aerodynamic component or structure 1, in which binding layer 3 a plurality of hard material particles 4 have been embedded. Generally speaking, the hard material particles 4 are microscale or nanoscale particles which predominantly can have the same or a similar diameter, or which can have different diameters. Generally speaking, the hard material particles 4 can have a diameter ranging from a few nanometres to many micrometres, depending on the type and characteristics as well as on the load acting on the aerodynamic components 1 to be protected.

The hard material particles 4 can comprise one or several of the following materials: ceramics, cubic boron nitride (CBM), silicates, carbides, other nitrides or diamond-like carbon particles. The binding layer 3 can be metallic, organic or inorganic, for example a layer of a suitable metal, an organic paint, and an organic adhesive or similar. The hard material particles 4 and the binding layer 3 thus form a system in which said microscale or nanoscale hard material particles 4 are inserted into a “soft” binder that is created by the binding layer 3. The binding layer 3 accounts, for example, for less than 40% by volume of the entire anti-erosion layer 2.

As a result of the considerable content of hard material in the particles 4, the anti-erosion layer 2 behaves like a solid hard layer, thus protecting the underlying surface of the component or structure 1. If a larger solid particle impacts, only the small hard material particles 4 are hit, without this inducing crack formation in the anti-erosion layer 2 as a result of the “soft” or elastic characteristic of the binding layer 3.

According to the exemplary embodiment, shown in FIG. 2, of a method for producing such an anti-erosion layer 2, the latter is applied by spraying onto the aerodynamic component or structure 1 a mixture comprising the material forming the binding layer 3 and the hard material particles 4. The material of the binding layer 3 can be a liquid, spray able material comprising one or several components; it can comprise a solvent and/or other additives. The mixture comprising the material that forms the binding layer 3 and comprising the hard material particles 4 is applied by a suitable spraying apparatus 5, as is well-known from the state of the art.

In the exemplary embodiment of a method according to the invention for producing the anti-erosion layer 2 on the aerodynamic component or structure 1 shown in FIG. 3, a material that forms the binding layer 3 is evaporated onto the component 1, wherein during the process the hard material particles 4 are inserted into the cloud of vapour of the material forming the binding layer 3, and together with this material are precipitated on the component 1. Feeding in the material of the binding layer 3 and the material of the hard material particles 4 first takes place separately; after mixing said materials they are then precipitated on the component 1 together so that they form a uniform homogeneous anti-erosion layer 2. The evaporation coating takes place by a vapour deposition apparatus 6, which is only shown schematically in FIG. 3 but which is known per se in the state of the art.

According to an exemplary embodiment of the invention, the anti-erosion layer is applied at a desired layer thickness d in a single operation. The layer thickness d can be in the nanometre range; it can be in the micrometre range; it can measure fractions of a millimetre or it can measure more than a millimetre.

If necessary, in addition, a covering layer can be applied to the anti-erosion layer 2, for example a covering layer that ensures particular smoothness or a covering layer which merely serves aesthetic purposes, for example, a paint coat.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. An anti-erosion layer for an aerodynamic component or structure, comprising:
a binding layer including a material that adheres to the aerodynamic component or structure; and
a plurality of hard material particles embedded in the binding layer.

2. The anti-erosion layer according to claim 1, wherein the plurality of hard material particles predominantly have a diameter in a micrometer range.

3. The anti-erosion layer according to claim 1, wherein the plurality of hard material particles predominantly have a diameter in a nanometre range.

4. The anti-erosion layer according to claim 1, wherein the plurality of hard material particles predominantly have a diameter of less than approximately 200 μm.

5. The anti-erosion layer according to claim 1, wherein the plurality of hard material particles predominantly have a diameter of between approximately 8 μm and approximately 80 μm.

6. The anti-erosion layer according to claim 1, wherein the plurality of hard material particles predominantly have a diameter of between approximately 0.8 μm and approximately 8 μm.

7. The anti-erosion layer according to claim 1, wherein the plurality of hard material particles predominantly have a diameter of between approximately 80 nm and approximately 800 nm.

8. The anti-erosion layer according to claim 1, wherein the plurality of hard material particles predominantly have a diameter of between approximately 8 nm and approximately 80 nm.

9. The anti-erosion layer according to claim 1, wherein the plurality of hard material particles predominantly have a diameter of less than approximately 8 nm.

10. The anti-erosion layer according to claim 1, wherein the plurality of hard material particles predominantly have a substantially similar diameter.

11. The anti-erosion layer according to claim 1, wherein the plurality of hard material particles have different diameters.

12. The anti-erosion layer according to claim 1, wherein the plurality of hard material particles are made from at least one material comprising a ceramic, cubic boron nitride, silicates, carbides.

13. The anti-erosion layer according to claim 1, wherein the binding layer is metallic.

14. The anti-erosion layer according to claim 1, wherein the binding layer is organic.

15. The anti-erosion layer according to claim 1, wherein the binding layer is inorganic.

16. The anti-erosion layer according to claim 1, wherein the binding layer accounts for less than approximately 60% by volume of the anti-erosion layer.

17. The anti-erosion layer according to claim 1, wherein the binding layer accounts for less than approximately 40% by volume of the anti-erosion layer.

18. A method for producing an anti-erosion layer on an aerodynamic component or structure, comprising:
forming a binding layer that includes a material that adheres to the aerodynamic component or structure; and
embedding a plurality of hard material particles in the binding layer; and
spraying a mixture comprising the material and the plurality of hard material particles onto the aerodynamic component or structure.

19. An anti-erosion layer for an aerodynamic component or structure, comprising:
forming a binding layer with a material;
forming a cloud of vapour of the material forming the binding layer;
introducing a plurality of hard material particles into the cloud of vapour of the material; and
evaporation coating the material onto the aerodynamic component or structure.
